(19) United States
(12) Patent Application Publication
(10) Pub. No.: US 2008/0302650 A1
(43) Pub. Date: Dec. 11, 2008

(54) Process to recover low grade heat from a fractionation system

(76) Inventor: Brandon Bello, Humble, TX (US)

Correspondence Address: FULBRIGHT & JAWORSKI, LLP, 1301 MCKINNEY, SUITE 5100, HOUSTON, TX, 77010-3095, US

(21) Appl. No.: 11/760,286

(22) Filed: Jun. 8, 2007

(51) Int. Cl. B01D 3/00

(52) U.S. Cl. 203/25; 202/154; 203/21

(57) ABSTRACT

This invention relates to methods and apparatus for the energy efficient separation of ethane and propane from any hydrocarbon feed, i.e., from natural gas, natural gas liquids, liquid natural gas, or from gases from refinery or petroleum plants.

### TECHNICAL FIELD

This invention relates to methods and apparatus for separating hydrocarbons more economically. More particularly, the methods and apparatus of the present invention are concerned with a method and apparatus for the energy efficient separation of ethane and propane from any hydrocarbon feed, i.e., from natural gas, natural gas liquids, liquid natural gas, or from gases from refinery or petroleum plants.

### BACKGROUND OF THE INVENTION

Natural gas is a combustible mixture of hydrocarbons. While natural gas primarily contains methane, the lightest hydrocarbon, it also contains varying amounts of heavier hydrocarbons. These heavier hydrocarbons include ethane (C₂H₆), propane (C₃H₈), n-butane (n-C₄H₁₀), isobutane (i-C₄H₁₀), pentanes (C₅H₁₂), and higher molecular weight hydrocarbons. When processed and purified, these heavier hydrocarbons are known as natural gas liquids (“NGL”) and the pentanes and higher molecular weight hydrocarbons are known as natural gasoline.

In addition to methane and heavier hydrocarbons, natural gas includes other impurities such as carbon dioxide (CO₂), nitrogen (N₂), hydrogen sulfide (H₂S), oxygen (O₂), and other rare gases such as argon, helium, nitrogen, and xenon. These impurities and heavier hydrocarbons must be separated from methane to produce pipeline quality methane. The heavier hydrocarbons are further separated into NGL components ethane, propane, butane, and natural gasoline.

Processes for separating hydrocarbons are well known in the art. While there are a great number of configurations for the various process used to separate hydrocarbons, the typical configuration for the processing of natural gas hydrocarbons comprises: 1) acid gas removal, 2) dehydration, 3) mercury removal, 4) nitrogen removal, 5) NGL separation, 6) NGL fractionation. Processes to remove contaminates from the hydrocarbon components include well known methods including absorption, adsorption, and cryogenic condensation. NGL separation is typically accomplished by either absorption using a lean oil absorption process or by cryogenic expansion of the hydrocarbons followed by distillation in a demethanizing column. The process involving a lean oil absorption can separate a mixture of methane and ethane from heavier hydrocarbons, while the cryogenic expansion-distillation process can separate methane from heavier hydrocarbons. The NGL fractionation processes employ distillation columns to separate the various NGL components. A deethanizer column is used to separate ethane from propane and the less volatile components and a depropanizer column is used to separate propane from the butane and natural gasoline components.

Separation of hydrocarbons using distillation systems requires the input of energy to generate the vapor needed by the process. However, many prior art systems have not been very energy efficient. The energy added to the process typically is removed later in the process as waste heat. To increase the efficiency of distillation systems, some prior art devices have used mechanical compression to elevate the temperature of the vapor so that the heat of vaporization can be recovered. However, as far as the inventors are aware, these improvements in distillation systems have not been applied to take advantage of recoverable energy in the light ends section of the NGL fractionation process.

### BRIEF SUMMARY OF THE INVENTION

The present invention is directed to a systems and processes for the separation of ethane, propane, and heavier hydrocarbons from a hydrocarbon containing feed. In the methods and apparatus of the present invention, a hydrocarbon feed is processed in a distillation tower, e.g., a deethanizer column or a depropanizer column, to separate lighter hydrocarbons from heavier NGL.

In the present invention, a hydrocarbon feed is introduced to a distillation column at one or more feed trays. Overhead products are recovered from the column and heavier NGL are collected from the bottom of the column. To improve the economics of the operation, the condensing temperature of the overhead products are increased by compression such that the temperature of the overhead product is greater then the boiling point of the bottom product. This provides the driving force necessary to transfer heat from the overhead product to the bottom product and reduce the amount of external heat necessary for the process. Further, the distillation column in the present invention is operated at lower temperature and pressures then conventional distillation columns used for the separation of hydrocarbons. These improvements reduce the overall energy consumption of the system by at least twenty-percent.

One embodiment of the invention recovers heat from the overhead product of the deethanizer using a refrigerant. The refrigerant is compressed to increase the temperature of the refrigerant to supply the driving force necessary to transfer heat to the bottom of the deethanizer column.

Another embodiment of the invention recovers heat from the overhead product of the depropanizer. The overhead product of the depropanizer is compressed to lower the operating pressure of the depropanizer and increase the temperature of the depropanizer product and supplies the driving force necessary to transfer heat the deethanizer column and/or the depropanizer column.

Another embodiment of the invention recovers heat from both the overhead product of both the deethanizer column and the depropanizer column. A refrigerant is used to recover heat from the deethanizer. The refrigerant is compressed to increase the temperature of the refrigerant to supply the driving force necessary to transfer heat to the deethanizer column. The overhead product of the depropanizer is compressed to increase the temperature of the depropanizer product and supplies the driving force necessary to transfer heat the deethanizer column and/or the depropanizer column.

In accordance with one aspect of the invention, there is provided process for the distillation of hydrocarbons for a hydrocarbon-containing feed, comprising the steps of: (1) introducing the hydrocarbon containing feed to a first distillation column; (2) withdrawing a first overhead product comprising ethane and substantially free from heavier hydrocarbons from the top of the first distillation column; (3) withdrawing a first bottoms product comprising propane and heavier hydrocarbons and substantially free from ethane from the bottom of the first distillation column; (4) feeding the first bottoms product from the bottom of the first distillation column into a second distillation column; (5) withdrawing a second overhead product comprising propane and substantially free from heavier hydrocarbons from the top of the second distillation column; (6) withdrawing a second bottoms product comprising heavier hydrocarbons from the bottom of the second distillation column; (7) using a refrigerant to recover heat from the first overhead product; (8) compressing the refrigerant to generate a first recompression heat; (8) and using at least some of the recompression heat produced as a heat source.

Wherein the process described above further comprises the step of using at least some of the first recompression heat as a heat source for the first distillation column. The hydrocarbon containing feed further comprises a mixture of ethane and heavier hydrocarbons, a mixture of ethane, propane, and heavier hydrocarbons, or a mixture of ethane and propane. Wherein the heavier hydrocarbon mixture further comprises a mixture of n-butane, methylpropane, and natural gasoline

Wherein the process described above further comprises compressing the refrigerant to a pressure of about 450 psia to about 550 psia. The first distillation column is operated at a pressure of about 245 psia to about 295 psia. The first distillation column is operated with a bottom temperature of about 100 degrees Fahrenheit to about 180 degrees Fahrenheit and a top temperature of about −30 degrees Fahrenheit to about 60 degrees Fahrenheit. The second distillation column is operated at a pressure of about 140 psia to about 245 psia, with a bottom temperature of about 180 degrees Fahrenheit to about 260 degrees Fahrenheit and a top temperature of about 70 degrees Fahrenheit to about 120 degrees Fahrenheit.

Wherein the process described above further comprises the step of compressing the second overhead produce to generate a second recompression heat and using at least some of the second recompression heat thereby produced is used as a heat source for the second distillation column. Wherein at least some of the second recompression heat thereby produced is used as a heat source for the first distillation column or for the first distillation column. Wherein the second overhead product is compressed to a pressure of about 435 psia to about 525 psia.

In accordance with another aspect of the invention, there is provided process for the distillation of hydrocarbons for a hydrocarbon-containing feed, comprising the steps of: (1) introducing the hydrocarbon containing feed to a first distillation column; (2) withdrawing an first overhead product comprising ethane and substantially free from heavier hydrocarbons from the top of the first distillation column; (3) withdrawing a first bottoms product comprising propane and heavier hydrocarbons and substantially free from ethane from the bottom of the first distillation column; (4) feeding the first bottoms product from the bottom of the first distillation column into a second distillation column; (5) withdrawing a second overhead product comprising propane and substantially free from heavier hydrocarbons from the top of the second distillation column; (6) withdrawing a second bottoms product comprising heavier hydrocarbons from the bottom of the second distillation column; (7) compressing the second overhead product to generate a first recompression heat; (8) and using at least some of the first recompression heat produced as a heat source.

Wherein the process described above further comprises the step of using at least some of the first recompression heat as a heat source for the first distillation column or the second distillation column. The hydrocarbon containing feed further comprises a mixture of ethane and heavier hydrocarbons, a mixture of ethane, propane and heavier, or a mixture of ethane and propane. Wherein the heavier hydrocarbons further comprises a mixture of a mixture of n-butane, methylpropane, and natural gasoline,

Wherein the process described above further comprises operating the first distillation column at a pressure of about 245 psia to about 495 psia, with a bottom temperature of about 100 degrees Fahrenheit to about 260 degrees Fahrenheit and a top temperature of about −30 degrees Fahrenheit to about 110 degrees Fahrenheit. Wherein the second distillation column is operated at a pressure of about 150 psia to about 295 psia. Wherein the second overhead product is compressed to a pressure of about 435 psia to about 525 psia. Wherein the second distillation column is operated with a bottom temperature of about 180 degrees Fahrenheit to about 260 degrees Fahrenheit and a top temperature of about 70 degrees Fahrenheit to about 120 degrees Fahrenheit.

Wherein the process described above further comprises the step of using a refrigerant to recover heat from the first overhead product, the refrigerant is compressed to generate a second recompression heat and at least some of the second recompression heat thereby produced is used as a heat source for the first distillation column. Wherein the refrigerant is compressed to a pressure of about 450 psia to about 550 psia.

In accordance with another aspect of the invention, there is provided an apparatus for the distillation of a hydrocarbon-containing feed, comprising: (1) a first distillation column having a least one stage; (2) a second distillation column having at least one stage; (3) a means for introducing a hydrocarbon containing feed into the first distillation column at one or more stages; (4) a means for withdrawing a first overhead product from the first distillation column; (5) a means for providing heat to the second distillation column; (6) a means for removing heat from the first overhead product using a refrigerant; (7) a means for compressing the refrigerant to generate a first recompression heat; (8) a means for using some of the first recompression heat as a heat source; (9) a means for withdrawing a first bottoms product from the first distillation column and introducing the first bottoms product into the second distillation column; (11) a means for withdrawing a second bottoms product from the second distillation column; (12) a means for withdrawing a second overhead product from the second distillation column; (13) and a means for providing heat to the second distillation column.

Wherein the apparatus described above further comprises a means for compressing the second overhead product and using some of the recompression heat of the second overhead product to heat the second distillation column or the first distillation column. Wherein at least one stage of the first distillation column comprises one or more sieve trays, valve trays, conventional or high efficiency trays, any conventional or high capacity trays, bubble cap trays, and structured or random packing. Wherein at least one stage of the second distillation column comprises one or more sieve trays, valve trays, conventional or high efficiency trays, any conventional or high capacity trays, bubble cap trays, and structured or random packing.

Wherein the means for compressing a second overhead product comprises one or more centrifugal compressors or reciprocating compressors.

Wherein the means for using some of the recompression heat of the second overhead product to heat the first distillation column comprises a shell and tube heat exchanger or a plate type heat exchanger.

Wherein the means for using some of the recompression heat of the second overhead product to heat the first distillation column comprises a shell and tube heat exchanger, or a plate type heat exchanger.

In accordance with another aspect of the invention, there is provided an apparatus for the distillation of a hydrocarbon-containing feed, comprising: (1) a first distillation column having a least one stage; (2) a second distillation column having at least one stage; (3) a means for introducing a hydrocarbon containing feed into the first distillation column at one or more stages; (4) a means for withdrawing a first overhead product from the first distillation column; (5) a means for removing heat from the first overhead product; (6) a means for withdrawing a first bottoms product from the first distillation column and introducing the first bottoms product into the second distillation column; (7) a means for providing heat to the second distillation column; (8) a means for withdrawing a second bottoms product from the second distillation column; (9) a means for withdrawing a second overhead product from the second distillation column; (10) a means for compressing the second overhead product to generate a first recompression heat; (11) a means for using some of the first recompression heat as a heat source; (12) and a means for providing heat to the second distillation column.

Wherein the apparatus described above further comprises a means for using some of the first recompression heat to heat the second distillation column or the first distillation column. Wherein at least one stage of the first distillation column comprises one or more sieve trays.

Wherein the means for compressing a second overhead product comprises one or more centrifugal compressors or reciprocating compressors

Wherein the means for using some of the recompression heat of the second overhead product to heat the first distillation column comprises a shell and tube heat exchanger or a plate type heat exchanger.

Wherein the means for using some of the recompression heat of the second overhead product to heat the second distillation column comprises a shell and tube heat exchanger or a plate type heat exchanger.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a process flow diagram of the improvement of the current invention to recover heat from the deethanizer, upgrading the heat by compressing, and using that heat to reduce fuel requirements.

FIG. 2 is a is a process flow diagram of the improvement of the current invention to recover heat from the depropanizer, upgrading the heat by compressing, and using the heat to reduce fuel requirements.

FIG. 3 is a process flow diagram of the improvement of the current invention to recover heat from the deethanizer and the depropanizer, upgrading the heat by compressing, and using the heat to reduce fuel requirements.

FIG. 4 is a process flow diagram of the improvement of the current invention to recover heat from the depropanizer operating at higher temperatures, upgrading the heat by compressing, and using the heat to reduce fuel requirements.

### DETAILED DESCRIPTION OF THE INVENTION

As used herein, “a” or “an” means one or more than one.

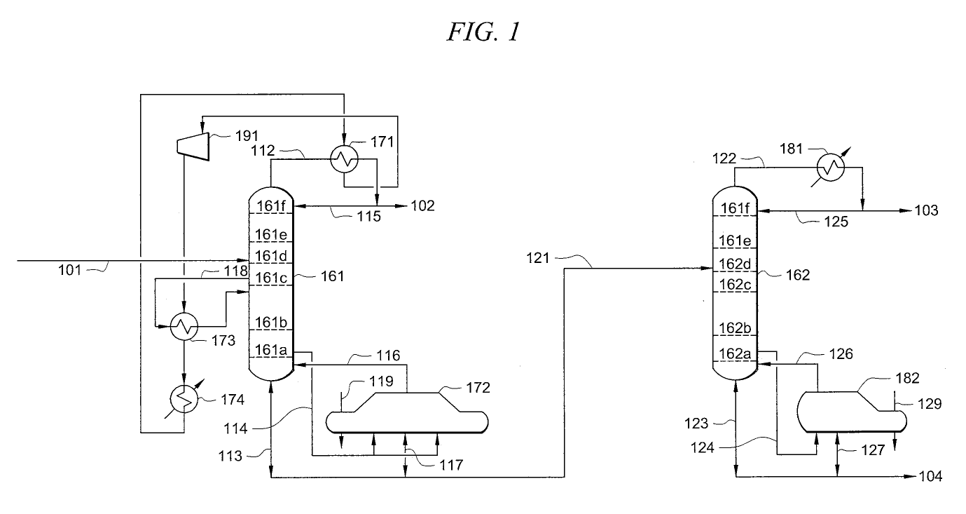

The methods and apparatus of the present invention will now be illustrated with reference to FIGS. 1 through 3. It should be understood, that these are merely illustrative and not exhaustive examples of the scope of the present invention and that variations which are understood by those having ordinary skill in the art are within the scope of the present invention.

Looking first at the system illustrated in FIG. 1, a hydrocarbon feed typically comprising ethane, propane, and heavier hydrocarbons is introduced to deethanizer 161 through feed line 101 at tray 161d. Deethanizer 161 is preferably operated at a pressure of about 270 psia, although other operating pressures may be used, has chimney trays 161a, 161b and 161c, and feed trays 161d, 161e, and 161f.

Lighter hydrocarbons, primarily ethane, are withdrawn from the top of deethanizer 161 via first overhead product line 112 typically at temperature of approximately 14 degrees Fahrenheit. Heat is recovered from the first overhead product by deethanizer condenser 171. Any condenser that can provide the necessary heat transfer duty requirement can be utilized as deethanizer condenser 171. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. After condensing, the first overhead product is split into two streams based on a typical reflux to distillate ratio (external reflux ratio) of about 0.8 to 0.9. The first portion is directed to line 102 as ethane product. The second portion is directed to line 115 and reintroduced into deethanizer column 161 at tray 161f as reflux to provide liquid traffic down the deethanizer column.

Heavier hydrocarbons are withdrawn from chimney tray 161a via line 114 and directed to deethanizer reboiler 172. Any reboiler that can provide the necessary heat transfer duty requirement can be utilized as deethanizer reboiler 172. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of deethanizer 161 via first bottoms product line 113 typically at a temperature of about 140 degrees Fahrenheit. Line 113 is connected to balance line 117 of deethanizer reboiler 172. Balance line 1.17 is used to maintain the same liquid level in deethanizer 161 and deethanizer reboiler 172. After absorbing heat in deethanizer reboiler 172, vapor from deethanizer reboiler 172 is directed to deethanizer 161 at chimney tray 161a via line 116. A first bottoms product is extracted via balance line 117 and is directed to depropanizer 162 through line 121.

Refrigerant is used to condense the first overhead product in deethanizer condenser 171. Any refrigerant having good thermodynamic properties such as a boiling point below the target temperature, a high heat of vaporization, a moderate density in liquid form, and relatively high gas density is preferred. In this embodiment, a propane refrigerant is used. The refrigerant is compressed in compressor 191 to a pressure of 500 psia. Any compressor capable of compressing the refrigerant to the necessary pressures can be utilized as compressor 191. This includes axial compressors, centrifugal compressors, diaphragm compressors, multistage compressors, reciprocating compressors, and rotary compressors. The refrigerant is directed to deethanizer side reboiler 173. Any heat exchanger that can provide the necessary heat transfer duty requirement can be utilized as deethanizer side reboiler 173. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. A side stream is drawn from chimney tray 161c and directed to deethanizer side reboiler 173 via line 118. The side stream is partially vaporized using the heat recovered from the deethanizer overhead product and the mixed phase stream is reintroduced to deethanizer 161 at chimney tray 161b. The refrigerant is then directed to heat exchanger 174 where it is cooled. Any heat exchanger that can provide the necessary heat transfer duty requirement can be utilized as heat exchanger 174. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. Finally, the refrigerant is directed to ethane condenser 171 and recovers the latent heat of condensation from the first overheat product.

The first overhead product is introduced into depropanizer 162 at feed tray 162d. Depropanizer 162 is typically operated at a pressure of about 190 psia, and has chimney trays 162a, 162b, and 162c and feed trays 162d, 162e, and 162f. Lighter hydrocarbons, primarily propane, are withdrawn from the top of depropanizer 162 via second overhead product line 122 at temperature of approximately 99 degrees Fahrenheit. The second overhead product is condensed with second overhead condenser 181 and split into two streams based on a reflux to distillate ratio (external reflux ratio) of about 1.55 to 1.75. Any condenser that can provide the necessary heat transfer duty requirement can be utilized as second overhead condenser 181. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. The first portion is directed to line 103 as propane product. The second portion is directed to line 125 and reintroduced into depropanizer 162 at tray 162f as reflux to provide liquid traffic down the depropanizer column.

A side stream is withdrawn from chimney tray 162a via line 124 and directed to depropanizer reboiler 182. Any reboiler that can provide the necessary heat transfer duty requirement can be utilized as depropanizer reboiler 182. Types of reboilers include kettle type reboilers, thermosyphon reboilers, fired heater reboilers, forced circulation reboilers, and stab-in reboilers. Heavier hydrocarbons, such as gasoline, are withdrawn from the bottom of depropanizer 162 via second bottoms product line 123 typically at a temperature of about 220 degrees Fahrenheit. Line 123 is connected to balance line 127 of depropanizer reboiler 182. Balance line 127 is used to maintain the same liquid level in depropanizer 162 and depropanizer reboiler 182. After absorbing heat in depropanizer reboiler 182, vapor from depropanizer reboiler 182 is directed to depropanizer 162 at chimney tray 162a via line 116. A second bottoms product is extracted via balance line 127 and is directed to line 104 as natural gasoline product.

The system described in FIG. 1 is intended to reduce the external fuel requirements of the system, in some cases, by approximately forty-percent or more. Taking into account the mechanical energy required to compress the refrigerant the overall reduction in energy consumption is typically approximately twenty-one percent.

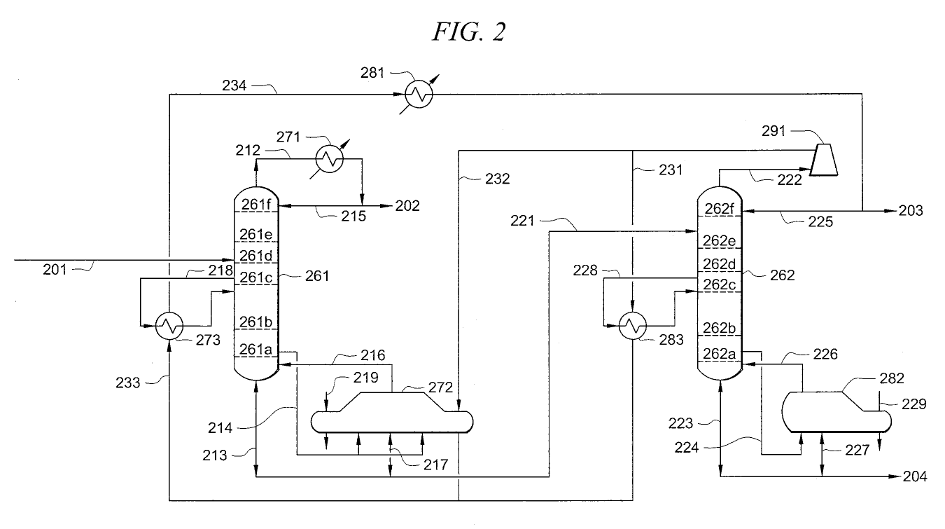

Turning now to FIG. 2, a similar reduction in energy required for the NGL separation process is achieved by compressing the overhead vapor of the depropanizer and transferring heat from the depropanizer overhead vapor to the depropanizer and/or the deethanizer.

Looking first at the ethane separation step, a hydrocarbon feed typically comprising ethane, propane, and heavier hydrocarbons is introduced to deethanizer 261 through feed line 201 at tray 261d. Deethanizer 261 is typically operated at a pressure of about 270 psia, and has chimney trays 261a, 261b, and 261c and feed trays 261d, 261e, and 261f.

Lighter hydrocarbons, primarily ethane, are withdrawn from the top of deethanizer 261 via first overhead product line 212 typically at a temperature of approximately 14 degrees Fahrenheit. Heat is recovered from the first overhead product by deethanizer condenser 271. Any condenser that can provide the necessary heat transfer duty requirement can be utilized as deethanizer condenser 271. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. After condensing, the first overhead product is split into two streams based on a typical reflux to distillate ratio (external reflux ratio) of about 0.8 to 0.9. The first portion is directed to line 202 as ethane product. The second portion is directed to line 215 and reintroduced into deethanizer 261 at tray 261f as reflux to provide liquid traffic down the deethanizer column.

A side stream withdrawn from chimney tray 261a via line 214 and directed to deethanizer reboiler 272. Any reboiler that can provide the necessary heat transfer duty requirement can be utilized as deethanizer reboiler 272. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of deethanizer 261 via first bottoms product line 213 typically at a temperature of about 140 degrees Fahrenheit. Line 213 is connected to balance line 217 of deethanizer reboiler 272. Balance line 217 is used to maintain the same liquid level in deethanizer 261 and deethanizer reboiler 272. After absorbing heat in deethanizer reboiler 272, vapor from deethanizer reboiler 272 is directed to deethanizer 261 at chimney tray 261a via line 216. A first bottoms product is extracted via balance line 217 and is directed to depropanizer 262.

The first bottoms product is introduced to depropanizer 262 through feed line 221 at tray 261c. Depropanizer 262 is typically operated at a pressure of about 190 psia, and has chimney trays 262a, 262b, and 262c and feed trays 262d, 262e, and 262f.

Lighter hydrocarbons, primarily propane, are withdrawn from the top of depropanizer 262 via second overhead product line 222 at temperature of approximately 99 degrees Fahrenheit. Heat is recovered from the first overhead product by compressing the second overhead product with second overhead compressor 291 to approximately 500 psia. Any compressor capable of compressing the refrigerant to the necessary pressures can be utilized second overhead compressor 291. This includes axial compressors, centrifugal compressors, diaphragm compressors, multistage compressors, reciprocating compressors, and rotary compressors. After recovering the heat, which will be described later, the second overhead product is condensed with second overhead condenser 281 and split into two streams based on a reflux to distillate ratio (external reflux ratio) of about 1.55 to 1.75. The first portion is directed to line 203 as propane product. The second portion is directed to line 225 and reintroduced into depropanizer 262 at tray 262e as reflux to provide liquid traffic down the depropanizer column.

After compressing, the second overhead product is split with a portion directed to depropanizer side reboiler 283 via line 231 and a portion directed to deethanizer reboiler 272 via line 232. A liquid side stream is taken from depropanizer 262 at chimney tray 262c via line 228 and directed to depropanizer side reboiler 283. A portion of the heat recovered from the second overhead product is transferred to the side stream from depropanizer 262 in depropanizer side reboiler 283. Any heat exchanger that can provide the necessary heat transfer duty requirement can be utilized for side reboiler 283. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. A portion of the side stream is vaporized and the mixed stream is returned to depropanizer 262 at chimney tray 262b thus transferring heat from the second overhead product to depropanizer 262.

Similarly, a portion of the heat recovered from the second overhead product is transferred to deethanizer reboiler 272. The heat transferred to deethanizer reboiler 272 vaporizes a portion of the first bottoms product. The vapor is returned to deethanizer 261, thus transferring heat from depropanizer 262 to deethanizer 261.

After transferring a portion of the heat recovered from the second overhead product, lines 231 and 232 are combined into line 233 which is directed to deethanizer side reboiler 273. Any heat exchanger that can provide the necessary heat transfer duty requirement can be utilized as deethanizer side reboiler 273. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. A liquid side stream is taken from deethanizer 261 at chimney tray 261c via line 218 and a portion of the liquid side stream is vaporized by transferring a portion of the heat recovered from the second overhead product to the liquid side stream and the mixed vapor/liquid stream is returned to deethanizer 261 at chimney tray 261b, thus transferring heat from the second overhead product to deethanizer 261. Finally, the second overhead product stream is condensed in depropanizer reflux condenser 281.

A side stream withdrawn from chimney tray 262a via line 224 and directed to deethanizer reboiler 282. Any reboiler that can provide the necessary heat transfer duty requirement can be utilized as deethanizer reboiler 282. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of depropanizer 262 via second bottoms product line 223 typically at a temperature of about 220 degrees Fahrenheit. Line 223 is connected to balance line 227 of depropanizer reboiler 282. Balance line 227 is used to maintain the same liquid level in depropanizer 262 and depropanizer reboiler 282. After absorbing heat in depropanizer reboiler 282, vapor from depropanizer reboiler 282 is directed to depropanizer 262 at chimney tray 262a via line 226. A second bottoms product is extracted via balance line 227 and is directed to product line 204.

This system described by FIG. 2 is intended to reduce the external fuel requirements of the system, in some cases, by approximately forty percent or more. Taking into account the mechanical energy required to compress the refrigerant the overall reduction in energy is typically approximately twenty percent.

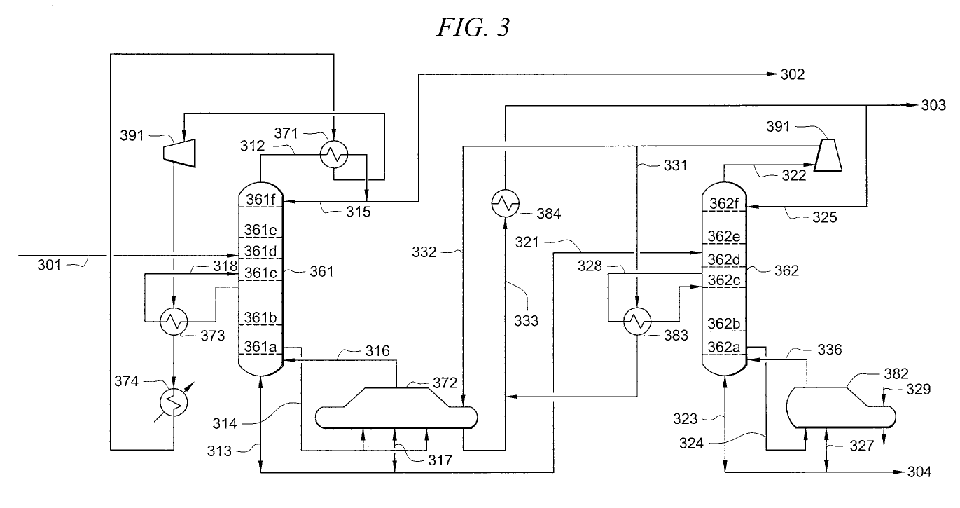

Turning now to FIG. 3, a similar reduction in energy required for the NGL separation process is achieved by compressing the overhead vapor of the depropanizer and transferring heat of the overhead vapor to the depropanizer and the deethanizer and by compressing the overhead vapor of the deethanizer and transferring the heat of the overhead vapor to the bottom of the deethanizer.

A hydrocarbon feed typically comprising ethane, propane, and heavier hydrocarbons is introduced to deethanizer 361 through feed line 301 at tray 361d. Deethanizer 361 is typically operated at a pressure of about 270 psia and has chimney trays 361a, 361b, and 361c and feed trays 361d, 361e, and 361f.

Lighter hydrocarbons, primarily ethane, are withdrawn from the top of deethanizer 361 via first overhead product line 312 typically at temperature of approximately 14 degrees Fahrenheit. Heat is recovered from the first overhead product by deethanizer condenser 371. Any condenser that can provide the necessary heat transfer duty requirement can be utilized as deethanizer condenser 371. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. After condensing, the first overhead product is split into two streams based on a typical reflux to distillate ratio (external reflux ratio) of about 0.8 to 0.9. The first portion is directed to line 302 as ethane product. The second portion is directed to line 315 and reintroduced into deethanizer column 361 at tray 361f as reflux to provide liquid traffic down the deethanizer column.

A side stream is withdrawn from chimney tray 361a via line 314 and directed to deethanizer reboiler 372. Any reboiler that can provide the necessary heat transfer duty requirement can be utilized as deethanizer reboiler 372. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of deethanizer 361 via first bottoms product line 313 typically at a temperature of about 140 degrees Fahrenheit. Line 313 is connected to balance line 317 of deethanizer reboiler 372. Balance line 317 is used to maintain the same liquid level in deethanizer 361 and deethanizer reboiler 372. After absorbing heat in deethanizer reboiler 372, vapor from deethanizer reboiler 372 is directed to deethanizer 361 at chimney tray 361a via line 316. A first bottoms product is extracted via balance line 317 and is directed to depropanizer 362 through line 321.

Refrigerant is used to condense the first overhead product in ethane condenser 371. Any refrigerant having good thermodynamic properties such as a boiling point below the target temperature, a high heat of vaporization, a moderate density in liquid form, and relatively high gas density is preferred. In this embodiment, a propylene refrigerant is used. The refrigerant is compressed in second overhead product compressor 391 to a pressure of 500 psia. Any compressor capable of compressing the refrigerant to the necessary pressures can be utilized as second overhead product compressor 391. This includes axial compressors, centrifugal compressors, diaphragm compressors, multistage compressors, reciprocating compressors, and rotary compressors. The refrigerant is directed to deethanizer side reboiler 373. Any heat exchanger that can provide the necessary heat transfer duty requirement can be utilized as deethanizer side reboiler 373. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. A side stream is drawn from chimney tray 361c vial line 318 and directed to deethanizer side reboiler 373 and is partially vaporized using the heat recovered from the deethanizer overhead product. The mixed phase stream is reintroduced to deethanizer 361 at chimney tray 361b. The refrigerant is then directed to heat exchanger 374 where it is cooled. Any heat exchanger that can provide the necessary heat transfer duty requirement can be utilized as heat exchanger 374. This includes shell and tube heat exchangers, double pipe and multitube section heat exchangers, plate type exchangers, plate-and-frame heat exchangers, brazed-plate- and frame heat exchangers, bayonet-tube heat exchangers, spiral-tube heat exchangers, falling-film heat exchangers, cryogenic-service spiral-tube heat exchangers, and air-cooled heat exchangers. Finally, the refrigerant is directed to ethane condenser 371 and recovers the latent heat of condensation from the first overheat product. Any condenser that can provide the necessary heat transfer duty requirement can be utilized as ethane condenser 371. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers.

The first bottoms product is introduced to depropanizer 362 through feed line 321 at tray 361d. Depropanizer 362 is typically operated at a pressure of about 190 psia, has chimney trays 362a, 362b, and 362c and feed trays 362d, 362e, and 362f.

Lighter hydrocarbons, primarily propane, are withdrawn from the top of depropanizer 362 via second overhead product line 322 at temperature of approximately 99 degrees Fahrenheit. Heat is recovered from the first overhead product by compressing the second overhead product with second overhead compressor 391 to approximately 500 psia. After recovering the heat, which will be described later, the second overhead product is condensed with depropanizer reflux condenser 384 and split into two streams based on a typical reflux to distillate ratio (external reflux ratio) of about 1.55 to 1.75. The first portion is directed to line 302 as propane product. The second portion is directed to line 325 and reintroduced into depropanizer 362 at tray 362f as reflux to provide liquid traffic down the depropanizer column.

After compressing, the second overhead product is split with a portion directed to depropanizer side reboiler 383 via line 331 and a portion directed to deethanizer reboiler 372 via line 332. A liquid side stream is taken from depropanizer 362 at chimney tray 362c via line 328 and directed to depropanizer side reboiler 383. A portion of the heat recovered from the second overhead product is transferred to side stream in depropanizer side reboiler 383. Any heat exchanger that can provide the necessary heat transfer duty requirement can be utilized as depropanizer side reboiler 383. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. A portion of the side stream is vaporized and the mixed stream is returned to depropanizer 362 at chimney tray 362b, thus transferring heat from the second overhead product to the bottom of depropanizer 362.

Similarly, a portion of the heat recovered from the second overhead product is transferred to deethanizer reboiler 372. The heat transferred to deethanizer reboiler 372 vaporizes a portion of the first bottoms product. The vapor is returned to deethanizer 361 via line 316 and reintroduced into deethanizer 361 at chimney tray 361a, thus transferring heat from depropanizer 362 to deethanizer 361.

After transferring a portion of the heat recovered from the second overhead product, lines 331 and 332 are combined into line 333 which is directed to depropanizer reflux condenser 384 where it is condensed. Any condenser that can provide the necessary heat transfer duty requirement can be utilized depropanizer reflux condenser 384. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers.

A side stream withdrawn from chimney tray 362a via line 324 and directed to deethanizer reboiler 382. Any reboiler that can provide the necessary heat transfer duty requirement can be utilized as deethanizer reboiler 382. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of depropanizer 362 via second bottoms product line 323 typically at a temperature of about 220 degrees Fahrenheit. Line 323 is connected to balance line 327 of depropanizer reboiler 382. Balance line 327 is used to maintain the same liquid level in depropanizer 362 and depropanizer reboiler 382. After absorbing heat in depropanizer reboiler 382, vapor from depropanizer reboiler 382 is directed to depropanizer 362 at chimney tray 362a via line 326. A second bottoms product is extracted via balance line 327 and is directed to product line 304.

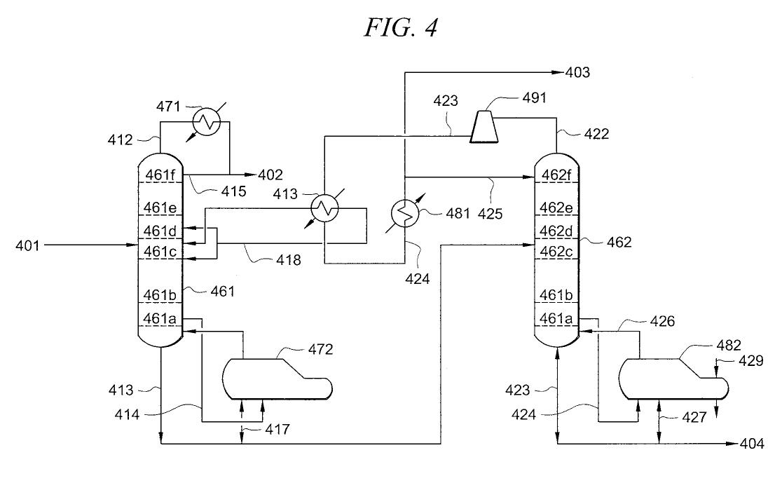

Turning now to FIG. 4, a retrofitting an existing unit can result in similar reduction in energy required for the NGL separation process. This is achieved by compressing the overhead vapor of the depropanizer and transferring heat from the depropanizer overhead vapor to the deethanizer.

Looking first at the ethane separation step, a hydrocarbon feed typically comprising ethane, propane, and heavier hydrocarbons is introduced to deethanizer 461 through feed line 401 at tray 461d. Deethanizer 461 is typically operated at a pressure of about 265 psia to about 495 psia, and has chimney trays 261a, 261b, and 261c and feed trays 261d, 261e, and 261f.

Lighter hydrocarbons, primarily ethane, are withdrawn from the top of deethanizer 461 via first overhead product line 412 typically at a temperature of approximately −10 degrees Fahrenheit to about 110 degrees Fahrenheit. Heat is recovered from the first overhead product by deethanizer condenser 471. Any condenser that can provide the necessary heat transfer duty requirement can be utilized as deethanizer condenser 471. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. After condensing, the first overhead product is split into two streams based on a typical reflux to distillate ratio (external reflux ratio) of about 0.8 to 0.9. The first portion is directed to line 402 as ethane product. The second portion is directed to line 415 and reintroduced into deethanizer 461 at tray 461f as reflux to provide liquid traffic down the deethanizer column.

A side stream withdrawn from chimney tray 461a via line 414 and directed to deethanizer reboiler 472. Any reboiler that can provide the necessary heat transfer duty requirement can be utilized as deethanizer reboiler 472. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of deethanizer 461 via first bottoms product line 413 typically at a temperature of about 120 degrees Fahrenheit to about 260 degrees Fahrenheit. Line 313 is connected to balance line 417 of deethanizer reboiler 472. Balance line 417 is used to maintain the same liquid level in deethanizer 461 and deethanizer reboiler 472. After absorbing heat in deethanizer reboiler 472, vapor from deethanizer reboiler 472 is directed to deethanizer 461 at chimney tray 461a via line 416. A first bottoms product is extracted via balance line 417 and is directed to depropanizer 462.

The first bottoms product is introduced to depropanizer 462 through feed line 421 at tray 461e. Depropanizer 262 is typically operated at a pressure of about 190 psia, and has chimney trays 462a, 462b, and 462c and feed trays 462d, 462e, and 462f.

Lighter hydrocarbons, primarily propane, are withdrawn from the top of depropanizer 462 via second overhead product line 422 at temperature of approximately 99 degrees Fahrenheit. Heat is recovered from the first overhead product by compressing the second overhead product with second overhead compressor 491 to approximately 500 psia. Any compressor capable of compressing the refrigerant to the necessary pressures can be utilized second overhead compressor 491. This includes axial compressors, centrifugal compressors, diaphragm compressors, multistage compressors, reciprocating compressors, and rotary compressors. After recovering the heat, which will be described later, the second overhead product is condensed with second overhead condenser 481 and split into two streams based on a reflux to distillate ratio (external reflux ratio) of about 1.55 to 1.75. The first portion is directed to line 403 as propane product. The second portion is directed to line 225 and reintroduced into depropanizer 462 at tray 462e as reflux to provide liquid traffic down the depropanizer column.

After compressing, the second overhead product directed to deethanizer side reboiler 473 via line 423. A liquid side stream is taken from deethanizer 461 at chimney tray 461c via line 418 and directed to deethanizer side reboiler 473. A portion of the heat recovered from the second overhead product is transferred to the side stream from deethanizer 461 in deethanizer side reboiler 473. Any heat exchanger that can provide the necessary heat transfer duty requirement can be utilized for side reboiler 473. This includes shell and tube heat exchangers, double pipe and multitube section heat exchangers, plate type exchangers, plate-and-frame heat exchangers, brazed-plate-and frame heat exchangers, bayonet-tube heat exchangers, spiral-tube heat exchangers, falling-film heat exchangers, cryogenic-service spiral-tube heat exchangers, and air-cooled heat exchangers. Finally, the second overhead product stream is condensed in depropanizer reflux condenser 481.

A side stream withdrawn from chimney tray 462a via line 424 and directed to deethanizer reboiler 482. Any reboiler that can provide the necessary heat transfer duty requirement can be utilized as deethanizer reboiler 482. Types of reboilers include kettle type reboilers, thermosyphon reboilers, fired heater reboilers, forced circulation reboilers, and stab-in reboilers. Heavier hydrocarbons, primarily propane and heavier hydrocarbons, are withdrawn from the bottom of depropanizer 462 via second bottoms product line 423 typically at a temperature of about 220 degrees Fahrenheit. Line 423 is connected to balance line 427 of depropanizer reboiler 482. Balance line 427 is used to maintain the same liquid level in depropanizer 462 and depropanizer reboiler 482. After absorbing heat in depropanizer reboiler 482, vapor from depropanizer reboiler 482 is directed to depropanizer 462 at chimney tray 462a via line 426. A second bottoms product is extracted via balance line 427 and is directed to product line 404.

This system described by FIG. 4 is intended to reduce the external fuel requirements of the system, in some cases, by approximately forty percent or more. Taking into account the mechanical energy required to compress the refrigerant the overall reduction in energy is typically approximately fifteen percent.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process for the distillation of hydrocarbons for a hydrocarbon-containing feed, comprising the steps of:
a. introducing said hydrocarbon containing feed to a first distillation column;
b. withdrawing a first overhead product comprising ethane and substantially free from heavier hydrocarbons, from the top of said first distillation column;
c. withdrawing a first bottoms product comprising propane and substantially free from ethane, from the bottom of the first distillation column;
d. feeding said first bottoms product from the bottom of said first distillation column into a second distillation column;
e. withdrawing a second overhead product comprising propane and substantially free from heavier hydrocarbons, from the top of said second distillation column;
f. withdrawing a second bottoms product comprising heavier hydrocarbons from the bottom of said second distillation column;
g. using a refrigerant to recover heat from said first overhead product; and
h. compressing said refrigerant to generate a first recompression heat and using at least some of the recompression heat thereby produced as a heat source.

2. The process of claim 1, further comprising the step of using at least some of said first recompression heat as a heat source for said first distillation column.

3. The process of claim 1 wherein said hydrocarbon containing feed further comprises a mixture of ethane and heavier hydrocarbons.

4. The process of claim 1 wherein said hydrocarbon containing feed further comprises a mixture of ethane, propane, and heavier hydrocarbons.

5. The process of claim 4 wherein said heavier hydrocarbons further comprises a mixture of n-butane, methylpropane, and natural gasoline.

6. The process of claim 1 wherein said hydrocarbon containing feed further comprises a mixture of ethane and propane.

7. The process of claim 1 wherein said refrigerant is compressed to a pressure of about 450 psia to about 550 psia.

8. The process of claim 1 wherein said first distillation column is operated at a pressure of about 245 psia to about 295 psia.

9. The process of claim 1 wherein said first distillation column is operated with a bottom temperature of about 100 degrees F. to about 180 degrees F. and a top temperature of about −30 degrees F. to about 60 degrees F.

10. The process of claim 1 wherein said second distillation column is operated at a pressure of about 140 psia to about 245 psia.

11. The process of claim 1 wherein said second distillation column is operated with a bottom temperature of about 180 degrees F. to about 260 degrees F. and a top temperature of about 70 degrees F. to about 120 degrees F.

12. The process of claim 1, further comprising the step of compressing said second overhead produce to generate a second recompression heat and using at least some of said second recompression heat thereby produced is used as a heat source for said second distillation column.

13. The process of claim 1, further comprising the step of compressing said second overhead product to generate a second recompression heat and using at least some of said second recompression heat thereby produced is used as a heat source for said first distillation column.

14. The process of claim 12, further comprising the step using at least some of said second recompression heat as a heat source for said first distillation column.

15. The process of claim 12, wherein said second overhead product is compressed to a pressure of about 435 psia to about 525 psia.

16. The process of claim 13 wherein said second overhead product is compressed to a pressure of about 435 psia to about 525 psia.

17. A process for the distillation of hydrocarbons for a hydrocarbon-containing feed, comprising the steps of:
a. introducing said hydrocarbon containing feed to a first distillation column;
b. withdrawing an first overhead product comprising ethane, from the top of said first distillation column;
c. withdrawing a first bottoms product comprising propane and heavier hydrocarbons and substantially free from ethane, from the bottom of the first distillation column;
d. feeding first bottoms product from the bottom of said first distillation column into a second distillation column;
e. withdrawing a second overhead product comprising propane and substantially free from heavier hydrocarbons, from the top of said second distillation column;
f. withdrawing a second bottoms product comprising heavier hydrocarbons from the bottom of said second distillation column; and
g. compressing said second overhead product to generate a first recompression heat;
h. and using at least some of the first recompression heat thereby produced as a heat source.

18. The process of claim 17, further comprising the step of using at least some of said first recompression heat as a heat source for said first distillation column.

19. The process of claim 17, further comprising the step of using at least some of said first recompression heat as a heat source for said second distillation column.

20. The process of claim 17 wherein said hydrocarbon containing feed further comprises a mixture of ethane and heavier hydrocarbons.

21. The process of claim 17 wherein said hydrocarbon containing feed further comprises a mixture of ethane, propane, and heavier hydrocarbons.

22. The process of claim 21 wherein said heavier hydrocarbons further comprises a mixture of n-butane, methylpropane, and natural gasoline.

23. The process of claim 17 wherein said hydrocarbon containing feed further comprises a mixture of ethane and propane.

24. The process of claim 17 wherein said first distillation column is operated at a pressure of about 245 psia to about 495 psia.

25. The process of claim 17 wherein said first distillation column is operated with a bottom temperature of about 100 degrees F. to about 260 degrees F. and a top temperature of about −30 degrees F. to about 110 degrees F.

26. The process of claim 17 wherein said second distillation column is operated at a pressure of about 150 psia to about 295 psia.

27. The process of claim 17 wherein said second overhead product is compressed to a pressure of about 435 psia to about 525 psia.

28. The process of claim 17 wherein said second distillation column is operated with a bottom temperature of about 180 degrees F. to about 260 degrees F. and a top temperature of about 70 degrees F. to about 120 degrees F.

29. The process of claim 17, further comprising the step of using a refrigerant to recover heat from said first overhead product, said refrigerant is compressed to generate a second recompression heat and at least some of said second recompression heat thereby produced is used as a heat source for said first distillation column.

30. The process of claim 29 wherein said refrigerant is compressed to a pressure of about 450 psia to about 550 psia.

31. An apparatus for distillation of a hydrocarbon-containing feed, comprising:
a. a first distillation column having a least one stage;
b. a second distillation column having at least one stage;
c. means for introducing a hydrocarbon containing feed into said first distillation column at one or more of said stages;
d. means for withdrawing a first overhead product from said first distillation column;
e. means for providing heat to said second distillation column;
f. means for removing heat from said first overhead product using a refrigerant;
g. means for compressing said refrigerant to generate a first recompression heat;
h. means for using some of the first recompression heat as a heat source;
i. means for withdrawing a first bottoms product from said first distillation column and introducing said first bottoms product into said second distillation column;
j. means for withdrawing a second bottoms product from said second distillation column;
k. means for withdrawing a second overhead product from said second distillation column; and
l. means for providing heat to said second distillation column.

32. The apparatus of claim 31 further comprising means for compressing said second overhead product and using some of the recompression heat of the second overhead product to heat said second distillation column.

33. The apparatus of claim 31 further comprising means for compressing said second overhead product and using some of the recompression heat of the second overhead product to heat said first distillation column.

34. The apparatus of claim 31 wherein at least one stage of said first distillation column comprises one or more sieve trays.

35. The apparatus of claim 31 wherein at least one stage of said second distillation column comprises one or more sieve trays.

36. The apparatus of claim 31 wherein said means for compressing a second overhead product comprises one or more centrifugal compressors.

37. The apparatus of claim 31 wherein said means for compressing a second overhead product comprises one or more reciprocating compressors

38. The apparatus of claim 31 wherein said means for using some of the recompression heat of said second overhead product to heat said first distillation column comprises a shell and tube heat exchanger.

39. The apparatus of claim 31 wherein said means for using some of the recompression heat of said second overhead product to heat said first distillation column comprises a plate type heat exchanger.

40. The apparatus of claim 31 wherein said means for using some of the recompression heat of said second overhead product to heat said first distillation column comprises a shell and tube heat exchanger.

41. The apparatus of claim 31 wherein said means for using some of the recompression heat of said second overhead product to heat said first distillation column comprises a plate type heat exchanger.

42. An apparatus for distillation of a hydrocarbon-containing feed, comprising:
a. a first distillation column having a least one stage;
b. a second distillation column having at least one stage;
c. means for introducing a hydrocarbon containing feed into said first distillation column at one or more of said stages;
d. means for withdrawing a first overhead product from said first distillation column;
e. means for removing heat from said first overhead product;
f. means for withdrawing a first bottoms product from said first distillation column and introducing said first bottoms product into said second distillation column;
g. means for providing heat to said second distillation column;
h. means for withdrawing a second bottoms product from said second distillation column;
i. means for withdrawing a second overhead product from said second distillation column;
j. means for compressing said second overhead product to generate a first recompression heat;
k. means for using some of the first recompression heat as a heat source; and
l. means for providing heat to said second distillation column.

43. The apparatus of claim 42 further comprising means for using some of the first recompression heat to heat said second distillation column.

44. The apparatus of claim 42 further comprising means for using some of the first recompression heat to heat said first distillation column.

45. The apparatus of claim 42 wherein at least one stage of said first distillation column comprises one or more sieve trays.

46. The apparatus of claim 42 wherein at least one stage of said first distillation column comprises one or more valve trays.

47. The apparatus of claim 42 wherein at least one stage of said first distillation column comprises one or more high capacity trays.

48. The apparatus of claim 42 wherein at least one stage of said first distillation column comprises one or more high efficiency trays.

49. The apparatus of claim 42 wherein at least one stage of said first distillation column comprises one or more bubble cap trays.

50. The apparatus of claim 42 wherein at least one stage of said first distillation column comprises random packing.

51. The apparatus of claim 42 wherein said means for compressing a second overhead product comprises one or more centrifugal compressors.

52. The apparatus of claim 42 wherein said means for compressing a second overhead product comprises one or more reciprocating compressors

53. The apparatus of claim 42 wherein said means for using some of the recompression heat of said second overhead product to heat said first distillation column comprises a shell and tube heat exchanger.

54. The apparatus of claim 42 wherein said means for using some of the recompression heat of said second overhead product to heat said first distillation column comprises a plate type heat exchanger.

55. The apparatus of claim 42 wherein said means for using some of the recompression heat of said second overhead product to heat said second distillation column comprises a shell and tube heat exchanger.

56. The apparatus of claim 42 wherein said means for using some of the recompression heat of said second overhead product to heat said second distillation column comprises a plate type heat exchanger.
